(19) United States
(12) Patent Application Publication
(10) Pub. No.: US 2008/0254753 A1
(43) Pub. Date: Oct. 16, 2008

(54) DYNAMIC VOLUME ADJUSTING AND BAND-SHIFTING TO COMPENSATE FOR HEARING LOSS

(75) Inventors: Jack Steenstra, San Diego, CA (US); Kirk Taylor, San Diego, CA (US); Liren Chen, San Diego, CA (US); Paul Hedtke, San Diego, CA (US); Yang Zhang, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/734,788

(22) Filed: Apr. 13, 2007

(51) Int. Cl. H04B 1/38

(52) U.S. Cl. 455/90.1; 455/205; 455/39; 455/508; 455/91

(57) ABSTRACT

A remote station apparatus comprises a transmit/receive circuit that is operable to transmit/receive signals to/from a communications network. A control processor receives signals from the transmit/receive circuit, the signals comprising an audio signal to be provided to a user through a user interface. The control processor is operable to modify the audio signal to shift, compress, and/or amplify one or more frequency bands based on predetermined audio signal modification parameters prior to providing the audio signal to the user interface. The audio signal modification parameters may be determined based on the user's hearing ability and/or preferences.

### BACKGROUND

1. Field

The technology of the present application relates generally to wireless communication devices, and more specifically to modifying of audio signals of such devices to compensate for hearing loss.

2. Background

As the world population increases, and as a larger percentage of the world population becomes more elderly, the number of people who experience hearing problems or hearing loss also increases. A healthy person with normal hearing can typically hear sound with frequencies between 20 Hz and 20 kHz. People perceive this sound through their ears in which the outer ear collects and focuses the sound. This sound is transferred to the ear canal and causes the eardrum to vibrate. This vibration transfers to the bones of the middle ear, and are then transmitted to the secondary tympanic membrane of the cochlea. The cochlea is fluid filled, and the vibrations carried in the fluid activate tiny hair-like sterocilia cells that vibrate at various perceived frequencies. The vibrations of the sterocilia cells are then earned by nerves to the brain. If a person's cochlear hairs are damaged or broken, the person will suffer from hearing loss. Typically, the loss is not uniform to all the sound with different frequencies. More serious loss tends to occur in the high frequency range, especially among people having long-term exposure to high noise level during their earlier years. This is because the cochlear hairs that pick up frequencies in the higher frequency ranges more prone to being damaged or broken.

In the United States alone it is estimated that over 40 million people are frequently exposed to harmful noise in their working environments. In 1999, the United States government paid over $291 million dollars to veterans alone who suffer from hearing loss. Furthermore, as the percentage of the world population that is over 60 years old is also continually increasing, the number of people with hearing is further increased as older people tend to have hearing loss more frequently that younger people.

Hearing loss is compensated in many cases by hearing aids. Such hearing aids may be placed into the ear canal and act to amplify sounds picked up by the hearing aid in order to enable the user of the hearing aid to better hear the sounds in their immediate surroundings. However, such hearing aids typically do not work well when the user of the hearing aid is talking on a telephone. This is due to feedback that commonly occurs between the hearing aid and the speaker within the telephone handset. Such feedback results in the inability of the person to hear anything from the telephone handset while the hearing aid is in place. Thus, people that suffer from hearing loss and wear hearing aids often do not use these hearing aids when speaking on the telephone. Many telephone handsets include volume control on the handset, and users that suffer from hearing loss may turn the handset volume to the maximum volume. However, such volume adjustments often do not provide enough compensation to allow the user to adequately hear the telephone conversation, thus often resulting in the person on the other end of the telephone having to speak very loudly. Furthermore, the volume control of a handset simply amplifies all of the audio signal frequencies that are sent to the earpiece of the telephone handset. As mentioned above, hearing loss is typically not uniform to all of the sound at different frequencies, and thus simply increasing the volume on a handset is not an optimum compensation to correct for the user's hearing loss. Therefore, mere is a need in the art for a telephone, or other audio generating device, that has modified audio suited to a particular person's needs and their particular hearing loss.

Furthermore, a significant number of people are either not literate with technology or not comfortable in using technology. With respect in hearing loss, as mentioned above, elderly people are more prone to hearing loss and are also more likely to be technologically illiterate or uncomfortable using technology. Thus, it would further be beneficial to have a telephone which is able to modify audio for a particular user without requiring any difficult or complex operations for properly enhancing the audio provided to a telephone handset.

### SUMMARY

Embodiments disclosed herein address the above stated needs by providing systems, methods, and apparatuses for dynamic band-shifting and volume adjusting to compensate for hearing loss. The band shifting and volume adjusting parameters are determined based on a user's hearing and may be modified to compensate for the particular user's hearing and/or preferences.

In one aspect, a remote station apparatus is provided comprising a transmit/receive circuit that is operable to transmit/receive wireless signals to/from a wireless communications network; a user interface; and control processor that receives signals from the transmit/receive circuit, the signals comprising an audio signal to be provided to a user through the user interface, wherein the control processor is operable to shift a first frequency band of the audio signal to a second frequency band based on predetermined audio signal modification parameters prior to providing the audio signal to the user interface. The audio signal modification parameters may be determined based on the user's hearing ability.

In another aspect, a method for modifying an audio signal from a remote station is provided. The method comprises the steps of receiving an audio signal at the wireless communications device; shifting at least a first frequency band of the audio signal to a second frequency band; amplifying at least a third frequency band of the audio signal; and providing the modified audio signal to an audio portion of a user interface.

In still another aspect, a method for modifying an audio signal from a wireless communications device is provided. The method comprises the steps of playing a first audio tone for a user of the wireless communications device; prompting the user to provide feedback based on the first audio tone; receiving the feedback; determining, based on the first audio tone and the feedback, an amplification parameter and a frequency shift parameter required for the audio signal.

### BRIEF DESCRIPTION OF THE DRAWINGS

FIG. 1 is a block diagram illustration of a wireless communications system of an exemplary embodiment of the disclosure;

FIG. 2 is a block diagram illustration of a remote station of an exemplary embodiment;

FIG. 3 is a block diagram illustration of a base station of an exemplary embodiment;

FIG. 4 is a block diagram illustration of a server of an exemplary embodiment;

FIG. 5 is a flow chart diagram illustrating the operational steps for determining audio signal modification parameters of an exemplary embodiment;

FIG. 6 is a flow chart diagram illustrating the operational steps of a remote station of an exemplary embodiment;

FIG. 7 is a flow chart diagram illustrating the operational steps of a remote station of another exemplary embodiment;

FIG. 8 is an illustration of frequency band shifting of an exemplary embodiment;

FIG. 9 is an illustration of frequency band compression of an exemplary embodiment; and

FIG. 10 is an illustration of frequency band volume adjustment of an exemplary embodiment.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

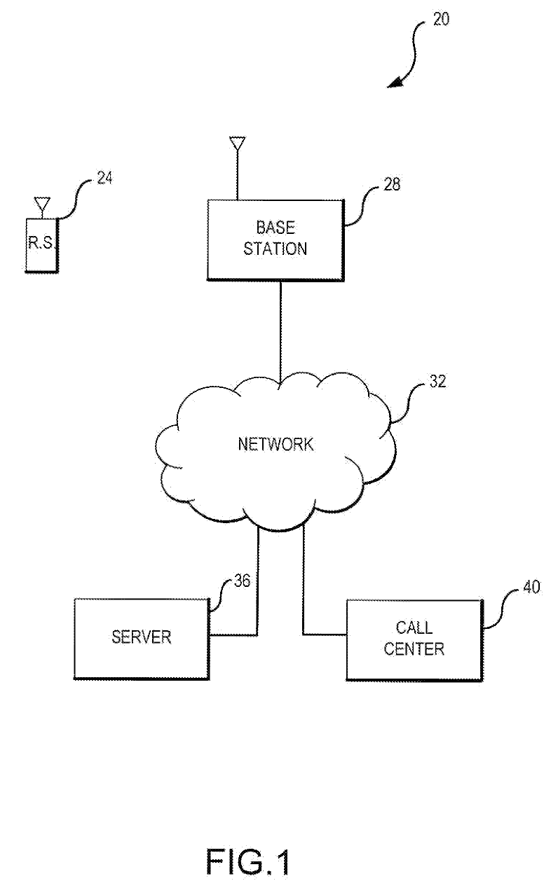

FIG. 1 illustrates a wireless communications network 20 of an exemplary embodiment. In this embodiment, the wireless communications network 20 includes a remote station 24, and a base station 28 that is interconnected to a network 32. Also included in this embodiment is a server 36 and call center 40 that are also interconnected to the network 32. While a single network 32 is shown for convenience, network 32 may be one or several interrelated networks including, a public switched network, the internet, or the like. The remote station 24, in this embodiment, is a wireless communication device such as a wireless telephone that communicates with base station 28 using one or more of many available wireless protocols such as CDMA. While the remote station 24 as discussed in many of the embodiments herein is described as a wireless telephone, it will be understood that other devices may also serve as a remote station, such as a personal computer, PDA, digital music player, among others. Furthermore, while a single remote station 24 is illustrated in FIG. 1, it will be understood that a typical wireless communications network 20 will include many remote stations 24 and that a single remote station 24 is illustrated for purposes of a simplified illustration and discussion. The remote station 24 may provide a user with many different functions, one of which is producing audio through one or more speakers that the user is intended to hear. In embodiments described herein, the remote station 24 produces audio that is modified based on a particular user's hearing in order to provide the user with audio that maybe more readily heard and understood relative to audio that has not been modified. In this manner, the user of the remote station 24 may hear audio that has been modified specifically based on that particular user's hearing capabilities.

The remote station 24 of the embodiment of FIG. 1 communicates with a base station 28. Such communications may include any available communications protocol, such as CDMA, although any other analog and/or digital communications protocol may also be used. Furthermore, while the embodiment if FIG. 1 is described with respect to a cellular network, it will be understood that the principles described herein are equally applicable to any wireless, or wired, network where a user may modify audio parameters for a remote station. The base station 28 is interconnected with network 32, and communicates with one or more other devices also interconnected with the network 32. While a single base station 28 is illustrated, it will be understood that wireless communications networks 20 typically include many base stations throughout the coverage area of the wireless communications network 20. Server 36, in this embodiment, is interconnected with the network 32, and may provide services and/or information to the remote station 24 related to modification of audio signals at the remote station 24 as will he described in more detail below. Call center 40 also is interconnected to the server 36 through with network 32 in this embodiment, and may have operators or assistants that may provide services and/or information to the remote station 24 or a user of the remote station 24 related to modification of audio signals at the remote station 24, as will also be described in more detail below. While this embodiment illustrates the server 36, call center 40, and base station 28 as separate items on the network 32, it will be understood that the functions of one or more of these items may be incorporated or co-located with one or more other items. Furthermore, as briefly mentioned above, while this embodiment illustrates a wireless communications network, the principles described also apply to traditional wired communications networks, in which a user terminal of the network would contain audio signal modification functionality as described herein with respect to the remote station. Additionally, the technology herein may be used for VOIP enabled telephones and devices as well.

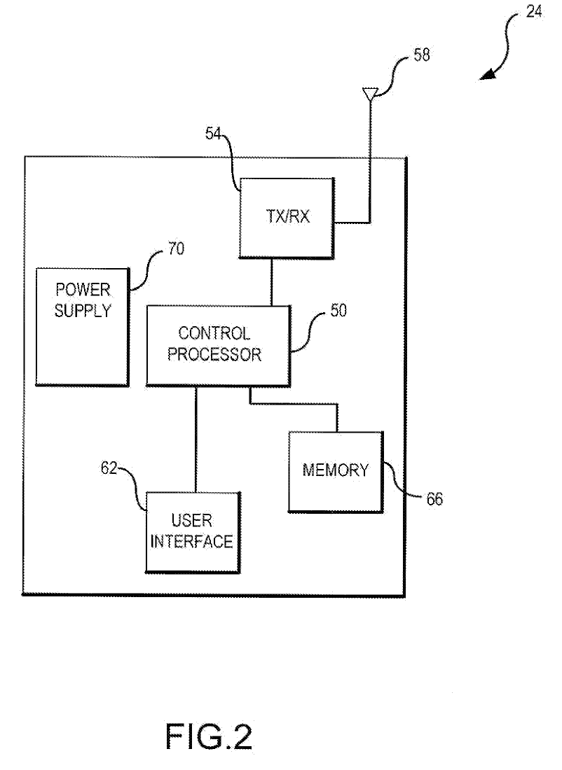

With reference now to FIG. 2, a remote station 24 of an exemplary embodiment is described in more detail. The remote station 24 includes several components, including a control processor 50. The control processor 50 controls the major functions of the remote station 24, and provides computing functionality to process many inputs and/or data as may be required for the operation of the remote station 24. Connected to the control processor 50 is transmit/receive circuitry 54 that transmits/receives wireless signals to/from an antenna 58. The transit/receive circuitry 54 performs functions typical of such components as used in wireless communications, such as modulating signals received item the control processor 50 that are to be transmitted over the antenna 58, and demodulating signals received from the antenna 58 and providing the demodulated signals to the control processor 50. The antenna 58 may be any antenna suitable for wireless communications in the wireless communications network 20, and while illustrated as a single antenna, may include one or more different send and receive antennas. A user interface 62 is interconnected with the control processor 50, and provides an audio, visual, and/or physical interface to a user. Such user interfaces 62 commonly include a speaker, microphone, visual display screen, and one or more physical input devices such as a keypad, trackwheel, and/or special input buttons that control speaker/ringer volume, etc. The control processor, in this embodiment, also is interconnected with a memory 66, that may be used to store processing instructions to be executed by the control processor 50. The memory 66 also may store data necessary or convenient for the operation of the remote station 24, such as data relating to one or more base stations, network timing information, and a directory of user contacts, to name but a few. Such memory 66 may include volatile and/or nonvolatile memory on any suitable storage media. In various exemplary embodiments described herein, the memory 66 is used to store audio signal modification parameters to be applied to audio signals prior to the audio signals being provided to a speaker. Such audio signal modification parameters are discussed in more detail below. The remote station 24 also includes a power supply 70 that may include one or more rechargeable batteries and an interlace to an external power source. Furthermore, while not illustrated in FIG. 2, many remote stations include additional components such as, for example, cable interfaces that allow the remote station to be interconnected with other computing devices, short range wireless transmitters/receivers such as BLUETOOTH technology devices, and/or CCD arrays for digital imaging.

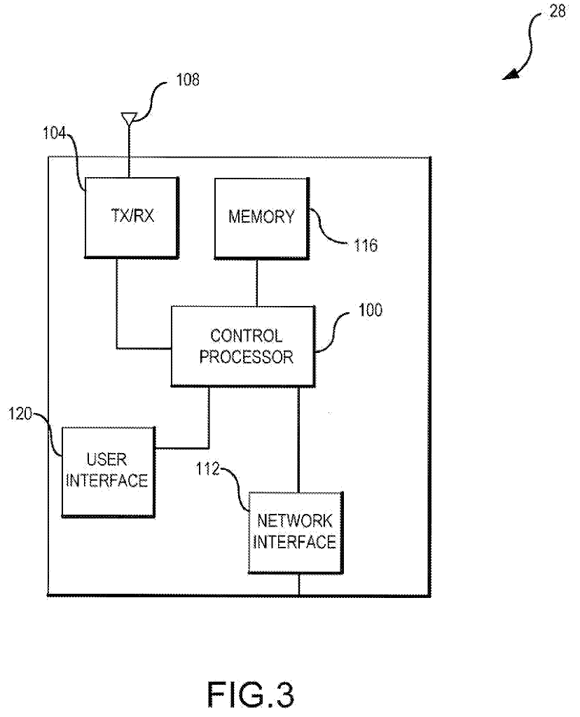

FIG. 3 is a block diagram illustration of a base station of an exemplary embodiment. In this embodiment, the base station 28 includes a control processor 100 that is interconnected to a transmit/receive subsystem 104 and antenna subsystem 108. The transmit/receive subsystem 104 provides capability to transmit/receive wireless communications to/from various different remote stations and/or other base stations. Furthermore, the transmit/receive subsystem 104 may also provide communications with one or more satellites. The antenna subsystem 108 may include one or more different transmit and receive antennas, and may include different antennas for communications with different devices or with different communication protocols. A network interface 112 is interconnected to the control processor 100, and provides an interface to network 32 (FIG. 1). A memory 116 is interconnected to the control processor 100, and may store processing instructions control processor 100 can execute. The memory 116 also may store data necessary or convenient for the operation of the base station 28, such as data relating to one or more other base stations, data relating to one or more remote stations within range of the base station 28, network timing information, and a directory of adjacent base stations, to name but a few. Such memory 116 may include volatile and/or nonvolatile memory on any suitable storage media. The base station 28 also includes a user interface 120, that network personnel may use to interface with the base station 28.

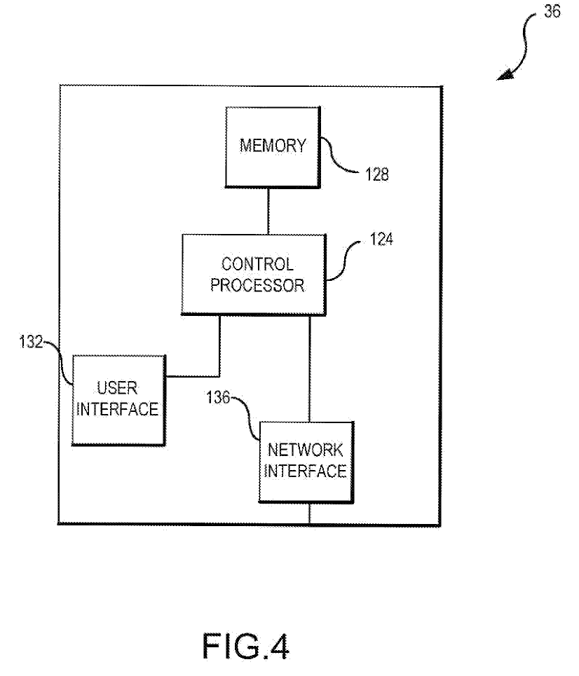

FIG. 4 is a block diagram illustration of a server of an exemplary embodiment. In this embodiment, the server 36 includes a control processor 124 that is interconnected to a memory 128, user interface 132, and a network interface 136. The memory 128 is used to store processing instructions the control processor 124 executes. The memory 128 also may store data necessary or convenient for the operation of the server, such as data relating audio signal modification parameters of one or more users of remote stations. Such memory 128 may include volatile and/or nonvolatile memory on any suitable storage media. The user interface 132 provides an interface for personnel to interface with the server 36. The network interface 136 provides an interface between the server 36 and the network 32 (FIG. 1). In one embodiment, personnel at the call center 40 (FIG. 1) access application programs of the server 36 and may use such applications to determine audio signal modification parameters for users of remote stations. The determination and function of audio signal modification parameters will be described in more detail below.

As discussed briefly above, various exemplary embodiments described herein provide a remote station that modifies audio signals prior to sending the audio signals to an output device such as a speaker. The modified audio signals allow a user of the remote station to more readily hear and understand the information contained in the audio signal. For example, a user of the remote station may have hearing loss at certain frequencies. Such a user may thus have difficulties hearing a voice of a person speaking to them through the remote station if the voice contains frequencies that correspond to the user's hearing loss. In various embodiments herein, an audio signal carrying such a voice may be modified to shift the frequency range of the voice to a different frequency range that is more readily heard by the user. Further embodiments herein provide for amplification of portions of an audio signal that are within certain frequency ranges to provide an amplified signal that the user more readily hears. Still further embodiments provide for both shifting of a frequency range to a second frequency range that the user more readily hears and amplification of the second frequency range. The particular modification that is performed on the audio signal is determined based on a particular user's hearing ability and preferences. The determination of how an audio signal is to be modified may be performed at the remote station, at a base station, at a call center, at a server, or some combination thereof.

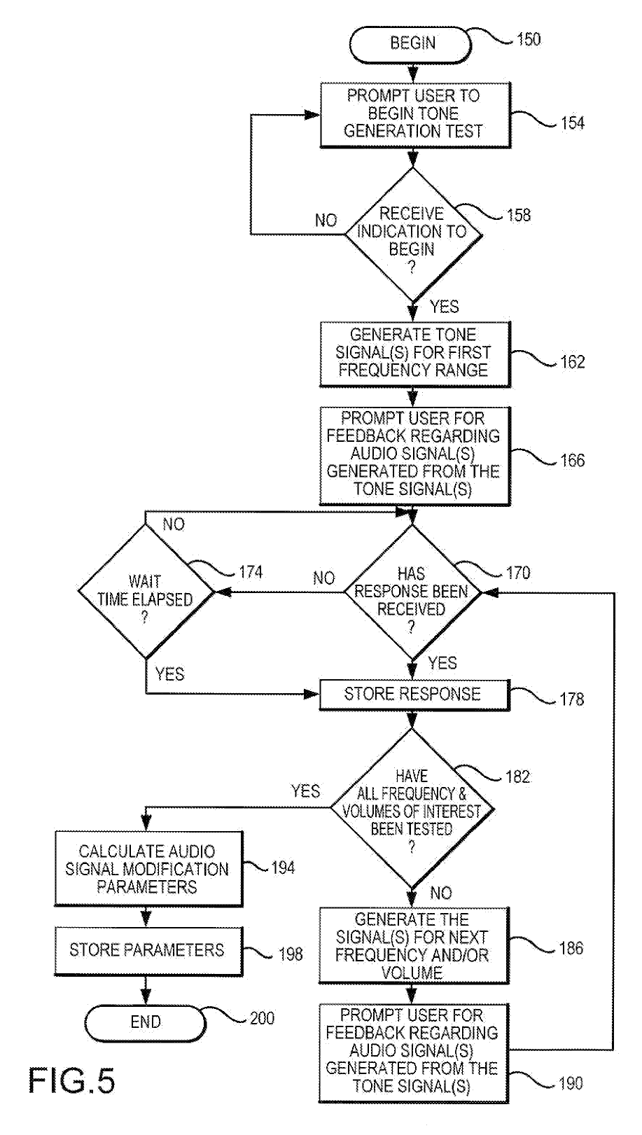

Referring now to FIG. 5, the operational steps for determining audio signal modification parameters are now described for an exemplary embodiment. It is noted, at the outset, that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art on reading the preset disclosure.

In the embodiment of FIG. 5, the operations start at block 150. Operations may start by a user initiating an audio profile generation function on the remote station, by an audiologist performing a test, or by an assistant or operator at a call center initiating a program on a server, to name but a few. At block 154, the user is prompted to begin a tone generation test. In this embodiment, as explained further below, audio tones are generated at different frequencies, and different volumes of tones at each frequency are generated also. Feedback is received from the user regarding if the user could hear the tones, and/or how well the user could hear the tones and/or whether the user preferred certain tones over other tones. This feedback is then used to determine audio signal modification parameters that can provide the user with audio that is more readily heard by the user than unmodified audio. At block 158, it is determined if an indication is received that the user is ready to begin. In one embodiment, the user interface of the remote terminal prompts the user with a visual and/or audio prompt to begin testing, which the user may respond to by depressing a designated key on a keypad of the remote terminal. The user may depress the designated key and the test then begins. In other embodiments, the user may enter a voice command to begin the testing, which is picked up by voice recognition software that determines the voice command matches a designated voice command to begin the testing. For example, an audio and/or visual prompt may he provided to the user interface instructing the user to say the word “yes” into the microphone of the user interface. The voice recognition software monitors an audio signal received from the microphone for a signal that indicates the user has said the word “yes” into the microphone. In still further embodiments, an operator located at a call center may have a telephone conversation with the user and ask the user if he/she is ready to begin. In any event, when it is determined that an indication to begin testing is received at block 158, tone signals) are generated at a first frequency range, as indicated at block 162. In one embodiment, the first frequency range is the bottom of the frequency range that is being tested. For example, if frequencies between 500 Hz and 4000 Hz are tested, the first tone may have a frequency of 500 Hz. At block 166, the user is prompted for feedback regarding the audio that was produced by the tone signal. The feedback may simply be that the user did or did not hear the audio, or the feedback may include additional information such as if the user did hear the audio, whether they heard it very well, or not well. In one embodiment, the tone is provided first at a relatively low volume, and subsequently be provided at a higher volume until the user provides feedback that the tone is heard. The prompt for feedback may be, for example, “say ‘now’ when you hear the tone.” Tones may be provided at the first frequency at a low volume, and provided at increasingly higher volumes until the user provides feedback. Similarly as described above, the feedback may be in the form of the user depressing a key on the user interface, providing a voice feedback that is monitored by voice recognition software, or informing an operator that the tone is heard.

At block 170, it is determined in a response has been received regarding the tone. If a response has not been received, it is determined at block 174 if a wait time has elapsed. Such a wait time may be, for example, 10 seconds. In this embodiment, a tone is generated and the user prompted for feedback. If the feedback is not received within 10 seconds, it is assumed that the user did not hear the tone. At block 178, the response is stored. At block 182, it is determined if all frequencies in the frequency range of interest have been tested. If all of the frequencies have not been tested, a tone is then generated for the next frequency to be tested in the frequency range, as noted at block 186. At block 190, the user is prompted for feedback regarding the audio generated from the tone signal, and the operations beginning at block 170 are then repeated. In this manner, it is determined how well the user is able to hear audio signals of different frequencies and/or different volumes at the different frequencies. When it is determined at block 182 that all of the frequencies and volumes of interest have been tested, audio signal modification parameters are calculated at block 194. The audio signal modification parameters are stored at block 198, and the operations end at block 200. The audio signal modification parameters may be used to modify audio of the remote station in a manner that the user of the remote station is better able to hear the audio. In one embodiment, after all of the frequencies and volumes of interest have been tested, an initial set of audio signal modification parameters are calculated and a test message is generated and then modified by the audio signal modification parameters to verify that the user is able to hear the test message. In the event that the user cannot hear the test message adequately, or the user does not like the way the test message sounds, the audio signal modification parameters may be modified and the test message repeated.

The operations described with respect to FIG. 5, as mentioned above, may be performed by executing a software application at the remote station. In such a manner, the user of the remote station may initiate the software application to customize the audio output of the remote station to an output that the user can more readily hear. Likewise, the operations may be performed by a base station or a server that are wirelessly connected to the remote station. In this manner, the remote station connects to the base station or server and the testing is then performed. In other embodiments, an operator at a call center assists the user and records the user responses to the different tone generations that are then used to calculate the audio signal modification parameters. In still further embodiments, the operations described in FIG. 4 may be performed in person at a clinic or doctor's office, for example, with the audio signal modification parameters calculated and manually entered and stored at the remote station. For example, a user may have an examination with an audiologist in which the audiologist characterizes the hearing abilities of the user. The audiologist, following the characterization, may use information from this characterization to provide the audio signal modification parameters. In still further embodiments, an interface may be provided that displays the audio signal modification parameters, and these parameters may then be manually adjusted to provide a modified audio signal that meets the user's needs.

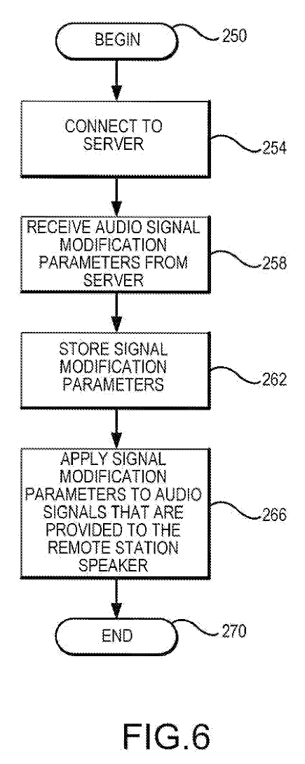

In some instances, a clinic or doctor's office may have specialized software that performs a battery of tests to characterize a user's hearing. In one embodiment, the results of such tests are stored at a server that then may use these results to calculate audio signal modification parameters that may then be provided to the remote station. FIG. 6 illustrates the operational steps of an exemplary embodiment where a server contains audio signal modification parameters. Such audio signal modification parameters may be determined, for example, by using specialized software, by performing tests as described with respect to FIG. 5, and/or by a manual entry of such parameters. In this embodiment, operations begin at block 250. At block 254 the remote station connects to the server. The remote station may connect to the server in any suitable manner, such as through a wireless connection with a base station that may connect with the server. The connection may also be a one-way message from the server to the remote station, such as a data message pushed to the remote station from the server. In other embodiments, the connection to the server may be through a short range wireless connection such as a BLUETOOTH wireless connection. At block 258, the remote station receives audio signal modification parameters from the server, and stores the audio signal modification parameters in a memory, as noted at block 262. The audio signal modification parameters, according to block 266, are applied to audio signals that are provided to the remote station speaker.

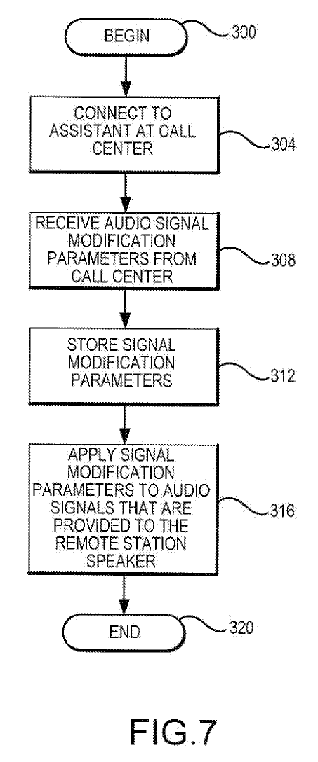

With reference now to FIG. 7, the operational steps of another exemplary embodiment are described. In this embodiment, a user of a remote station places a voice call to a call center and a person or automated system at the call center assists the user with the generation of audio signal modification parameters for the user. In this embodiment, operations begin at block 300. At block 304, the remote station connects to an assistant or operator at a call center. As mentioned, a user of the remote station may place a voice call to an operator at the call center. Such an operator may be a live person that is trained in determining and providing audio signal modification parameters, or may be an automated virtual operator that provides voice prompts and may have voice recognition capabilities to respond to voice replies of a user. Many users may desire to simply place such a voice call rather then use a software application. A user may desire to speak with an operator for one of many different reasons. For example, the user may dislike using such software compared to speaking with an operator, the user may have difficulty operating the user interface in a manner required by the software due to limited manual dexterity, the user may not understand the software, and/or the user may speak a different language than provided by the software prompts. In any event, the operator at the call center may assist the user with the test to determine modification parameters, such as the operations described with respect to FIG. 5. The operator at the call center may also have access to previously determined audio signal modification parameters, or the operator at the call center may have access to data needed to calculate audio signal modification parameters. In any case, the operator at the call center obtains or calculates the audio signal modification parameters. At block 308, the remote station receives the audio signal modification parameters from the call center. At block 312, the remote station stores the audio signal modification parameters. These audio signal modification parameters are then applied, at block 316, to audio signals that are provided to a speaker of the remote station, thus providing the user with audio that is more likely to be heard and understood.

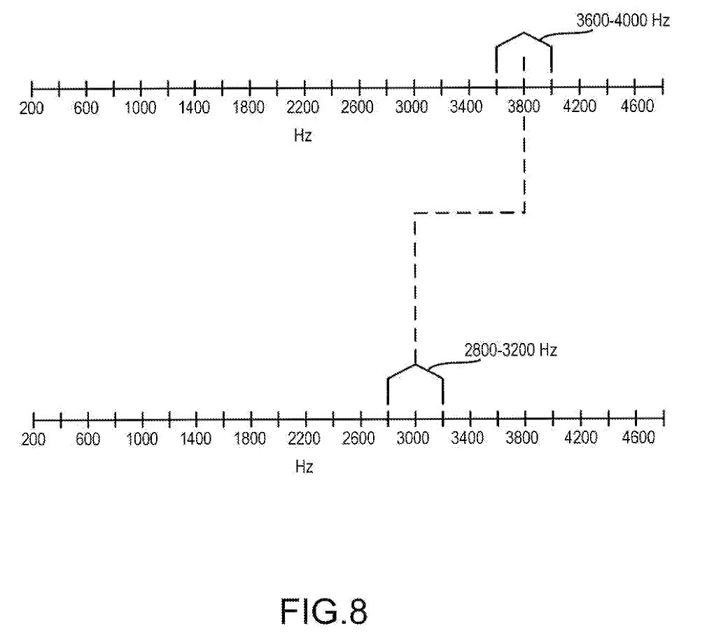

As discussed above, the remote station of the various exemplary embodiments provides modified audio such that a user of the remote station can more readily hear the audio. Such users may have differing amounts and levels of hearing loss, as well as hearing loss that is different depending upon a particular frequency contained in the audio. For example, a user may be an elderly male that has particular difficulty hearing frequencies between 3600 Hz and 4000 Hz. Such hearing loss may be the result any of a number of potential causes, such as, for example, years of working without adequate hearing protection in an environment that had high levels of noise in this frequency range. The exposure to these high levels of noise at these particular frequencies may have caused damage to the user's cochlear hairs that respond to this frequency range, thus creating a frequency gap in the user's hearing. Such a frequency gap may be determined in a manner as discussed above, and audio signal modification parameters are calculated to compensate for this frequency gap in the user's hearing. Such audio signal modification parameters may be a frequency shift of the frequency band that corresponds to the user's frequency gap in hearing. Such a frequency shift may take signals that are present within the frequency band of 3600 Hz to 4000 Hz, and shift this frequency band to 2800 Hz to 3200 Hz. Such a band shift is illustrated in FIG. 8. In such an embodiment, the controller in the remote station receives the audio signal from the transmit/receive circuit, and determines portions of the audio signal that fall within the frequency band of 3600 Hz to 4000 Hz. The portion of the audio signal in this frequency band is then shifted to the lower frequency band of 2800 Hz to 3200 Hz, and this band shifted signal is then provided to the speaker of the user interface. The audio in the shifted frequency band may also be mixed with other audio that is also contained within this frequency band in order to reduce the likelihood that any audio information is lost from the audio signal. Thus, the frequency gap in the user's hearing is compensated.

As will be recognized, the audio heard by the user in such an embodiment will be distorted compared to the actual audio contained in the original audio signal. For example, if the audio signal contains speech that is relatively high pitched, such as a woman's voice, the modified audio signal will contain this same speech but in a relatively lower pitch. Thus, the woman's relatively high pitched voice will sound more like a voice of a man with a relatively low pitch. While this distortion may be present, the user in such an embodiment will be better able to hear the voice and may prefer the distorted audio rather than a relatively undistorted audio that they are not able to hear.

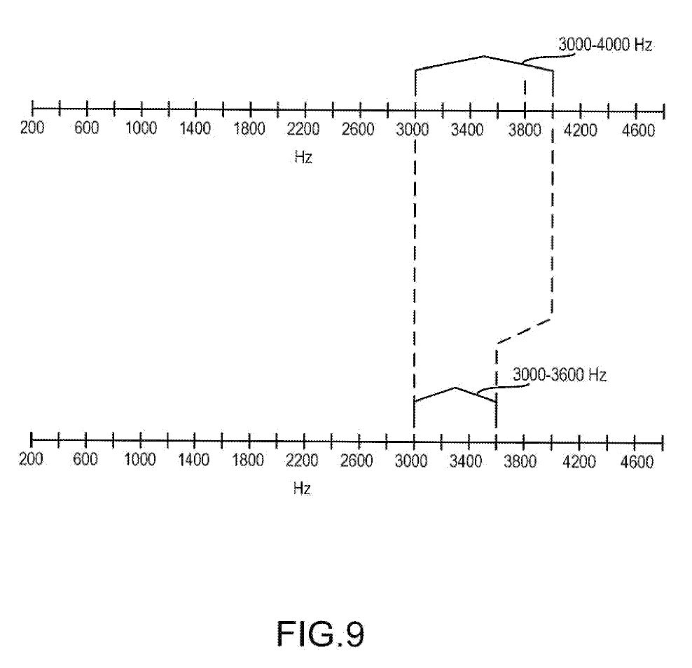

The audio signal modification parameters may also include compression of certain frequency bands. For example, illustrated in FIG. 9 is a compression of the 3000 Hz to 4000 Hz frequency band to the 3000 Hz to 3600 Hz frequency band. Such a frequency band compression may be appropriate for a user that is able to hear within a particular frequency band, but less able to hear frequencies outside of this frequency band. In such a case, compression of frequency bands may be desirable in order for the user to adequately hear the audio signal. Furthermore, such frequency compression may be desired in order to maintain the same perceived dynamic range of a shifted frequency band. For example, the logarithmic nature of the frequency response of human hearing results in perceiving the band from 200 Hz to 400 Hz the same as the band from 2 kHz to 4 kHz. So, if a frequency band is moved to a lower band, the frequency range may be compressed in order to maintain the same perceived dynamic range, and thus maintain the dynamic richness of a person's voice, in the shifted frequency band. Likewise, if a frequency band moved to a higher band, the frequency range may be expanded to maintain the same perceived dynamic range of audio. As discussed above, such a modified audio signal will often have significant distortion compared to the original audio signal, but may be desirable to the user is as much as the user is able to hear the audio. For example, such a modified audio signal may result in a relatively high pitched woman's voice sounding like a lower pitched male voice. In cases where the user does not desire to have such distortion present, the audio signal modification parameters may be further adjusted to produce audio that is more suited to the user's desires.

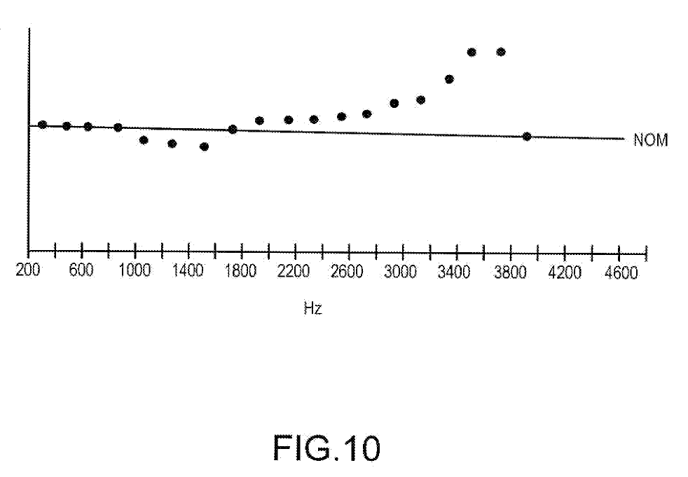

In addition to frequency band shifting and frequency band compression, audio signal modification parameters may also include amplification and/or attenuation of certain frequency bands. FIG. 10 illustrates an example of amplification/attenuation of various frequency bands between 200 Hz and 4000 Hz. In this example, the audio signal has a nominal level (NOM), with several of the frequency bands amplified or attenuated relative to the nominal level. As mentioned above, certain users may have more hearing loss in certain frequency bands relative to other frequency bands. In cases where such hearing loss may be compensated for by amplifying the frequencies in these bands, such amplification may be more desirable than a shift of the frequency band to a different frequency band.

While frequency band-shifting, frequency band compression, and volume adjustment are illustrated in different drawing figures, audio signal modification parameters stored in a remote station will commonly contain all of the types of modifications that are then applied to different frequency bands of the audio signal. Such volume adjustments, frequency band shifting, and/or frequency band compression to be applied to an audio signal may be determined on a user-by-user basis, depending upon the hearing of the particular user. Furthermore, a user may experiment with various different sets of audio signal modification parameters and find a particular audio signal modification that is to the liking of the user. Additionally, a user of the remote station may elect to turn off audio modifications. Thus, if the remote station is used by more than one user, with a primary user having hearing loss, the remote station may be set to modify the audio unless such modification is turned off. Furthermore, a remote station may contain two or more different sets of audio signal modification parameters, one of which may be selected by a user. This would thus allow the remote station to be shared by two or more users that each have unique hearing loss and thus have unique audio signal modification parameters. Such multiple sets of audio signal modification parameters may also be used in applications in which a user has different hearing loss profiles in each ear, and thus provide such a user with an appropriate signal modification for the ear that the user is using. In such an embodiment, the user of the remote station may be prompted to enter audio signal modification parameters in any suitable manner, and to identity a profile that the audio signal modification parameters are to be associated with. A user, when using the remote station, may then select the appropriate profile and the audio signal modification parameters associated with the selected profile will be applied to the audio signal, thus providing a modified audio signal for the particular user, and/or the particular ear that a user has selected.

In addition, still further embodiments provide a remote station, server, or other component used to determine modification parameters, that may be pre-loaded with a list of audio signal modification parameter profiles that match a range of typical user profiles. For example, a user may provide information, for example, related to age group, gender, and/or professional exposure to high noise level. This information may then be used to select a baseline modification profile that the particular user may fine tune to their particular needs. Similarly, a user, after setting audio signal modification parameters for a user, these parameters may then be used as a baseline for the user who may then further refine based on their particular needs.

While several exemplary embodiments have been discussed in which audio signal modification parameters are determined and then applied to audio signals, a user may also re-adjust audio signal modification parameters at any given time.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM). Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a remote terminal. In the alternative, the processor and the storage medium may reside as discrete components in a remote terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A remote station apparatus, comprising:
a transmit/receive circuit that is operable to transmit/receive wireless signals to/from a wireless communications network;
a user interface; and
a control processor that receives signals from the transmit/receive circuit, the signals comprising an audio signal to be provided to a user through said user interface,
wherein said control processor is operable to shift a first frequency band of said audio signal to a second frequency band based on predetermined audio signal modification parameters prior to providing said audio signal to said user interface, and wherein said audio signal modification parameters are determined based on the hearing ability of the user.

2. The remote station apparatus, as claimed in claim 1, wherein said control processor is further operable to modify a third frequency band of said audio signal by amplifying said third frequency band.

3. The remote station apparatus, as claimed in claim 1, wherein said second frequency band comprises frequencies that are lower than said first frequency band.

4. The remote station apparatus, as claimed in claim 1, wherein said control processor is further operable to modify said second frequency band by amplifying said second frequency band.

5. The remote station apparatus, as claimed in claim 1, wherein said first frequency band is wider than said second frequency band, and said control processor is further operable to modify said audio signal by compressing said first frequency band and shifting said compressed first frequency band to said second frequency band.

6. The remote station apparatus, as claimed in claim 1, wherein said control processor is further operable to receive a signal from a base station that contains information comprising said audio signal modification parameters.

7. The remote station apparatus, as claimed in claim 1, wherein said control processor is further operable to receive an input from said user interface, said input containing information comprising said audio signal modification parameters.

8. The remote station apparatus, as claimed in claim 7, wherein said control processor is operable to execute instructions stored in a memory that instruct the control processor to provide an audio signal to the user and prompt the user to provide input regarding the audio signal, and wherein said audio signal modification parameters are determined based on the input.

9. The remote station apparatus, as claimed in claim 1, wherein said control processor is further operable to provide an audio signal to said user interface based on baseline audio modification parameters, receive input from said user interface, and adjust one or more of said audio signal modification parameters based on the input.

10. The remote station apparatus, as claimed in claim 9, wherein said baseline audio modification parameters are selected for the user based on at least one of the user's: age, gender, and previous exposure to high noise levels.

11. The remote station apparatus, as claimed in claim 1, wherein said control processor is further operable to receive an input from said user interface and selectably turn on and off the modification of said audio signal based upon the received input.

12. The remote station apparatus, as claimed in claim 1, wherein said controller is further operable to connect to a server and receive information from said server comprising said audio signal modification parameters.

13. The remote station apparatus, as claimed in claim 1, wherein said control processor is further operable to connect a user of the remote station to an operator at a call center, the operator determining said audio signal modification parameters and transmitting said audio signal modification parameters to the remote station.

14. The remote station apparatus, as claimed in claim 1, wherein said controller is further operable to associate said audio signal modification parameters with a first profile and associate a second set of audio signal modification parameters with a second profile, and wherein the user may select the first or second profile for said audio signal modification.

15. A server apparatus, comprising:
a network Interface to transmit/receive signals to/from one or more remote stations;
a controller operable to provide the remote station with audio signal modification parameters, said audio signal modification parameters defining modification of an audio signal to be provided by the remote station to a user of the remote station,
wherein said audio signal modification parameters comprise parameters to shift a first frequency band of said audio signal to a second frequency band and are determined based on hearing ability of the user of the remote station.

16. The server apparatus, as claimed in claim 15, wherein said control processor is operable to transmit one or more audio and/or video prompts to said remote station, and receive feedback from the remote station based on the prompts, wherein said audio signal modification parameters are determined based upon said feedback.

17. The server apparatus, as claimed in claim 15, wherein said control processor receives input from an operator at a call center, the operator communicating with the user of the remote station to determine said modification parameters.

18. The server apparatus, as claimed in claim 15, wherein said control processor provides baseline audio modification parameters and transmits one or more audio and/or video prompts to said remote station, and receives feedback from the remote station based on the prompts, wherein said audio signal modification parameters are determined based upon said feedback.

19. The server apparatus, as claimed in claim 15, wherein said audio signal modification parameters comprise one or more frequency bands that are to be amplified relative to other frequency bands.

20. The server apparatus, as claimed in claim 15, wherein said second frequency band is lower than said first frequency band.

21. The server apparatus, as claimed in claim 15, wherein said audio signal modification parameters comprise frequency bands that are to be shifted to different frequency bands, and amplification parameters that are to be applied to one or more frequency bands.

22. The server apparatus, as claimed in claim 15, wherein said control processor is further operable to receive said audio signal modification parameters from a call center and provide said received audio signal modification parameters to said remote station.

23. A wireless communication system, comprising:
a base station;
a remote station;
wherein said remote station is operable to selectably modify an audio signal provided to a user of the remote station based on the hearing ability of the user.

24. The wireless communication system, as claimed in claim 23, wherein said remote station is operable shift one or more frequency bands to different frequency bands.

25. The wireless communication system, as claimed in claim 23, wherein said remote station is operable to amplify one or more frequency bands of the audio signal.

26. The wireless communication system, as claimed in claim 23, wherein said remote station is operable to shift a first frequency band to a second frequency band, the second frequency band having lower frequencies than the first frequency band, and being compressed relative to the first frequency band.

27. The wireless communication system, as claimed in claim 23, wherein said remote station is operable to shift one or more frequency bands to different frequency bands, and to amplify one or more frequency bands relative other frequency bands.

28. The wireless communication system, as claimed in claim 23, further comprising a server interconnected with said base station, wherein said server is operable to provide an audio signal to the user of the remote station and prompt the user to provide input regarding the audio signal, and wherein said server provides said remote station with said audio signal modification parameters based on the input.

29. The wireless communication system, as claimed in claim 23, wherein said base station is operable to connect a user of said remote station to an operator, the operator determining said audio signal modification parameters and providing said audio signal modification parameters to said remote station.

30. The wireless communication system, as claimed in claim 23, wherein said remote station comprises a control processor that is operable to prompt the user with one or more audio and/or visual prompts and determine said audio signal modification parameters based on feedback from the user to said prompts.

31. A method for modifying an audio signal from a wireless communications device, comprising:
receiving an audio signal at the wireless communications device;
shifting at least a first frequency band of said audio signal to a second frequency band;
amplifying at least a third frequency band of said audio signal; and
providing the modified audio signal to an audio portion of a user interface.

32. The method, as claimed in claim 31, further comprising before said step of receiving:
playing a first audio tone for a user of the wireless communications device;
prompting the user to provide feedback based on the first audio tone;
receiving said feedback; and
determining, based on said first audio tone and said feedback, an amplification parameter and a frequency shift parameter required for said audio signal.

33. The method, as claimed in claim 32, wherein said first audio tone is selected based on a baseline modification profile for the user that is based on at least one of the user's: age, gender, and previous exposure to high noise levels.

34. The method, as claimed in claim 31, further comprising before said step of receiving:
receiving art audio signal modification parameter from a server.

35. The method, as claimed in claim 31, further comprising before said step of receiving:
connecting a user of the wireless communications device to an operator, the operator to determine audio signal modification parameters;
receiving audio signal modification parameters from the operator; and
storing said audio signal modification parameters at the wireless communications device.

36. A method for modifying an audio signal, comprising:
providing audio signal modification parameters to a remote station, said audio signal modification parameters comprising one or more frequency bands that are to be shifted to different frequency bands, and amplification parameters for one or more frequency bands of an audio signal; and
providing an audio signal to the remote station that is to be modified based on said audio signal modification parameters.

37. The method, as claimed in claim 36, further comprising before said step of providing audio signal modification parameters:
playing a first audio tone for a user of the remote station;
prompting the user to provide feedback on the first audio tone;
receiving feedback based on said prompt; and
determining, based on said first audio tone and said feedback, amplification and frequency shift parameters to be applied to audio signals at the remote station.

38. The method, as claimed in claim 37, wherein said first tone is selected based on a baseline modification profile for the user that is based on at least one of the user's: age, gender, and previous exposure to high noise levels.

39. The method, as claimed in claim 36, further comprising:
connecting a user of the remote station to an assistant, the assistant determining audio signal modification parameters; and
receiving the audio signal modification parameters from the assistant.

40. A computer readable medium embodying a method for modifying an audio signal of a remote station, the method comprising:
receiving an audio signal;
modifying said audio signal based upon user defined audio signal modification parameters comprising frequency band shift and frequency band amplification parameters; and
playing said modified audio signal to a user.

41. The computer readable medium, as claimed in claim 40, wherein said method further comprises:
prompting a user of the remote station for feedback based upon an audio tone provided to the user; and
determining said audio signal modification parameters based upon said tone and said feedback.

42. The computer readable medium, as claimed in claim 40, wherein said method further comprises:
connecting a user of the remote station to an assistant, the assistant determining audio signal modification parameters; and
receiving said audio signal modification parameters from the assistant.

43. A remote station apparatus, comprising:
means for receiving an audio signal;
means for modifying said audio signal, said modifying including shifting a first frequency band of said audio signal to a second frequency band, and amplifying one of more frequency bands of said audio signal relative to other frequency bands; and
interface means for providing audio from said modified audio signal to a user.

44. The remote station apparatus, as claimed in claim 43, further comprising:
means for playing a first audio tone for the user;
means for prompting the user to provide feedback based on the first audio tone; and
means for determining, based on first audio tone and said feedback, an amplification and frequency shift required for said audio signal.

45. The remote station apparatus, as claimed in claim 43, further comprising:
means for receiving audio signal modification parameters from a server.

46. The remote station apparatus, as claimed in claim 43, further comprising:
means for connecting the user of the remote station to an assistant, the assistant to determine audio signal modification parameters;
means for receiving audio signal modification parameters from the assistant; and
means for storing said modification parameters.

47. A server apparatus, comprising:
means for determining audio signal modification parameters for a remote station, the audio signal modification parameters comprising frequency shift and amplification parameters for an audio signal; and
means for providing said audio signal modification parameters to the remote station.

48. The server apparatus, as claimed in claim 47, wherein said means for determining audio signal modification parameters comprises:
means for transmitting a first audio tone to the remote station, the first audio tone to be provided to a user of the remote station;
means for receiving feedback from a user of the remote station, the feedback based on the first audio tone; and
means for determining said audio signal modification parameters based on said first audio tone and said feedback.

49. The server apparatus, as claimed in claim 47, further comprising:
means for connecting a user of the remote station to an assistant, the assistant to determine audio modification parameters;
means for receiving said audio modification parameters from the assistant.

50. A data packet comprising a signal that provides audio modification parameters for audio to be played by a remote station, said audio modification parameters including one or more frequency bands that are to be shifted to different frequency bands, and one or more amplification parameters to be applied to one or more frequency bands relative to other frequency bands, said audio signal modification parameters based on a hearing profile of a user of the remote station.
